(19) United States
(12) Patent Application Publication
(10) Pub. No.: US 2006/0050438 A1
(43) Pub. Date: Mar. 9, 2006

(54) Method and apparatus for attaching center hub

(75) Inventor: Akira Mizuta, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/216,011

(22) Filed: Sep. 1, 2005

(30) Foreign Application Priority Data
Sep. 3, 2004 (JP) 256792/2004

(51) Int. Cl. G11B 23/03

(52) U.S. Cl. 360/133; 29/603.03

(57) ABSTRACT

A disk cartridge holding therein a disk which is centrally attached with a disk-shaped center hub via a tacky ring formed of ring-shaped double sided adhesive tape material is produced by: driving a base film with tacky rings being attached on an upper surface of the base film; feeding the base film such that at least one of the tacky rings is positioned at a hub-attaching position; at the hub-attaching position, temporarily attaching each center hub onto the base film via each tacky ring; and guiding the base film in a direction in which the base film is folded back about an apex of a wedge portion of a guide member provided with the wedge portion, such that the base film is caused to be peeled off from the tacky ring.

### BACKGROUND OF THE INVENTION

1. Field of the Invention

This invention relates to a method and apparatus for producing disk cartridges having a flat housing holding therein a rotary disk as an information recording medium, to which a disk-shaped center hub is centrally affixed via a tacky ring formed of ring-shaped double sided adhesive tape material. More specifically, the invention relates to a method and apparatus for attaching such a center hub to the rotary disks.

2. Description of the Related Art

Conventionally, mobile devices such as digital cameras, etc., use very small magnetic disk cartridges called “clik! (registered trademark)” as recording media (see, for example, U.S. Pat. No. 6,133,544).

FIG. 7A is a plan view and FIG. 7B is a bottom view, showing a magnetic cartridge of the conventional magnetic disk cartridge, and FIG. 8 is an enlarged sectional view showing essential parts of the magnetic disk cartridge taken along line 8-8 in FIG. 7B.

This disk cartridge 1 comprises: a flat housing (width 50 mm, depth 55 mm, thickness 1.95 mm) which is constituted by a resin frame 2 (which is called a spacer or stabilizer) including a push portion 2a to be pushed with a finger when loading the disk cartridge to a drive device (not shown), and upper and lower shells 3 and 4 formed of a thin metal sheet of about 0.2 mm thick; and a 46.5 mm diameter magnetic disk 5 having a 40 MB storage capacity which is held in the flat housing such that it becomes rotatable when the disk cartridge 1 is mounted in the drive device. A center hub (center core) 10 having a center hole 10a is centrally affixed to the magnetic disk 5 via a tacky ring 15 which is formed of ring-shaped double sided adhesive tape material as shown in FIG. 8.

The magnetic disk cartridge 1 is designed to be loaded in a TYPE II PC card type drive device (width 53 mm, depth 85 mm, thickness 5 mm, not shown) by insertion of the disk cartridge 1 into a slot provided in the drive device. Each of the upper and lower shells 3, 4 has a wedge-shaped opening 6 formed to allow a recording/reproducing magnetic head of the disk drive to access the surface of the magnetic disk 5. A rotary shutter 7 having an opening 7a for pivotally opening and closing the opening 6 is held inside the upper and lower shells 3 and 4 with the rotary shutter 7 being urged towards its closing direction by means of a spring member (not shown).

The rotary shutter 7 is constituted by upper and lower shutter members 7U and 7D which are engaged with each other at the peripheries thereof. As is apparent from FIG. 8, the upper shutter member 7U is rotatably supported by a small-diameter cylinder 3a of the upper shell 3. The cylinder 3a projects inwardly from the lower surface of the upper shell 3. A retaining member 9 (called a center pin) is welded to the extremity of the cylinder 3a in order to prevent the upper shutter member 7U from falling off from the cylinder 3a such that the retaining member 9 is disposed within the central aperture 10a of the center hub 10.

At the central portion of the lower shell 4, a circular center hole 4a for exposing the center hub 10 towards the outside is formed. A large diameter cylinder 7Da to be loosely engaged with the edge of the center hole 4a of the lower shell 4 protrudes downward from the central portion of the lower shutter member 7D. The lower shell 4 rotatably supports the lower shutter member 7D via the large diameter cylinder 7Da. The distal end of the cylinder 7Da is caulked to form a flange 12 which serves to prevent the lower shutter member 7D from falling off from the lower shell 4. A liner 13, which is for wiping off dirt and dust deposited on the magnetic disk and constructed of, for example, a nonwoven fabric, is affixed to the inner surface of each of the upper and lower shutter members 7U and 7D.

As shown in FIG. 7B, an arcuate groove 4b concentric with the rotary shutter 7 is formed in the lower shell 4, while a shutter knob 7b which protrudes through the arcuate opening 4b and travels along this arcuate opening 4b to allow opening and closing of the rotary shutter 7 is affixed to the lower shutter member 7D. When the magnetic disk cartridge 1 is loaded into the drive device, the shutter knob 7b engages with an engaging wall of the drive device and the rotary shutter 7 is in turn rotated to its open position where its opening 7a is aligned with both openings 6 of the upper and lower shells 3 and 4, so that the magnetic disk 5 is exposed through the openings 6 of the upper and lower shells 3 and 4. On the other hand, when the magnetic disk cartridge 1 is unloaded from the drive device, the rotary shutter 7 is returned to its closed position shown in FIGS. 7A and 7B by means of a spring member (not shown).

Conventionally, a typical process for centrally attaching a tacky ring 15 to the aforementioned magnetic disc 5 via a center hub 10 comprises the steps of: arranging tacky rings 15, each of which has been produced by stamping a double sided adhesive tape into a ring shape, on a strip-like carrying base film; feeding the base film such that the tacky rings 15 are positioned to a first hub-attaching position on a one-by-one basis; loading one center hub 10 on a hub-attaching head; moving the hub-attaching head loaded with a center hub 10 to the first hub-attaching position; vertically lowering the center hub 10 onto the tacky ring 15 for attaching lower surface of the center hub 10 to the upper surface of the tacky ring 15; immediately vertically elevating the hub-attaching head; peeling off the base film from the tacky ring 15 which has been attached to both the upper surface of the base film and the lower surface of the center hub 10; and attaching at a second hub-attaching position the center hub 10 to a magnetic disk 5 via the tacky ring 15 attached to the lower surface of the center hub 10.

In the base film peeling method as described above, the base film is peeled off based on the difference of the adherence of the tacky ring 15 with respect to the center hub 10 and the adherence of the tacky ring 15 with respect to the base film, i.e., based on the fact that the adherence of the tacky ring 15 with respect to the center hub 10 is larger than the adherence of the tacky ring 15 with respect to the base film. Such a base film peeling method may suffer from problems such as an insufficient peeling stability, and occurrence of wrinkles on the tacky ring 15 and air entrapment between the center hub 10 and the magnetic disk 5 when the center hub 10 is attached to the magnetic disk 5.

### SUMMARY OF THE INVENTION

In view of the foregoing observations and description, an object of the invention is to provide a center hub attaching method and apparatus that enables stable peeling (removal) of a base film.

According to a first aspect of the invention, there is provided a method of attaching a disk-shaped center hub of a disk cartridge to a rotary disk as an information recording medium, wherein the disk cartridge comprises the rotary disk; and a flat housing in which the rotary disk is rotatably held, and wherein the disk-shaped center hub is centrally attached to the rotary disk via a tacky ring formed of ring-shaped double sided adhesive tape material;
the method comprising the steps of:
(1) providing and arranging a plurality of the tacky rings on a strip-like carrying base film;
(2) feeding the base film such that at least one of the tacky rings is positioned at a first hub-attaching position;
(3) at the first hub-attaching position, temporarily attaching each center hub onto the base film via each tacky ring;
(4) guiding the base film in a direction in which the base film is folded back such that the base film is caused to be peeled off from the tacky ring which has been attached to both an upper surface of the base film and a lower surface of the center hub; and
(5) thereafter, at a second hub-attaching position, attaching the center hub onto the disk via the tacky ring which has been attached to the lower surface of the center hub.

In this case, it is preferable to guide the base film in a direction in which the base film is folded back about an apex T of a wedge portion of a guide member provided with the wedge portion, such that the base film is caused to be peeled off from the tacky ring.

It is also preferable that the base film is peeled off from the tacky ring after a lapse of a predetermined time period (for example, at least 3 seconds) from attachment of the center hub onto the base film at the first hub-attaching position.

According to a second aspect of the invention, there is provided an apparatus for attaching a disk-shaped center hub of a disk cartridge to a rotary disk as an information recording medium, wherein the disk cartridge comprises the rotary disk; and a flat housing in which the rotary disk is rotatably held, and wherein the disk-shaped center hub is centrally attached to the rotary disk via a tacky ring formed of ring-shaped double sided adhesive tape material;
the apparatus comprising:
a base film driving device for driving and feeding a carrying base film with a plurality of the tacky rings being arranged on an upper surface of the base film, such that at least one of the tacky rings is positioned at a first hub-attaching position;
a first hub-attaching device for attaching at the first hub-attaching position the center hub to the base film via the tacky ring;
a guide device for guiding the base film in a direction in which the base film is folded back about an apex T of a wedge portion provided in the guide device, such that the base film is caused to be peeled off from the tacky ring which has been attached to both an upper surface of the base film and a lower surface of the center hub; and
a second hub-attaching device for attaching at a second hub-attaching position the center hub to the disk via the tacky ring which has been attached to the lower surface of the center hub.

It is preferable that the apex of the wedge portion is located at a position spaced downstream from the first hub-attaching position along the base film traveling direction.

According to the hub-attaching method of the present invention, the base film is guided in a direction in which the base film is folded back, whereby the base film is caused to be peeled off from the tacky rings which have been attached to both an upper surface of the base film and a lower surface of the center hub. Therefore, the base film is gradually peeled off from the front edge of the tacky ring, which ensures stable peeling. This eliminates the problems of wrinkle occurrence on the tacky ring and air entrapment between the center hub and the magnetic disk when the center hub is attached to the magnetic disk.

Since the aforementioned base film is peeled off after a lapse of a predetermined time period from attachment of the center hub onto the base film at the aforementioned first hub-attaching position, the tacky ring is more securely attached to the lower surface of the center hub, which produces an effect of stabilizing the attached state of the center hub with respect to the disk.

According to the hub attaching apparatus of the invention, the apex of the wedge of the guide member is located at a position spaced downstream from the first hub-attaching position along the base film traveling direction, and therefore a certain time period elapses during movement of the base film from the first hub-attaching position to the apex of the wedge of the guide member. This makes it possible to produce the aforementioned effect.

### BRIEF DESCRIPTION OF THE DRAWINGS

FIG. 1 is a schematic front view of a center hub attaching apparatus of the invention;

FIGS. 2A to 2E are illustrative diagrams showing step by step a procedure for producing a carrying base film having thereon tacky rings used by the center hub attaching apparatus shown in FIG. 1;

FIG. 3 is a schematic plan view of the center hub attaching apparatus shown in FIG. 1;

FIG. 4 is a schematic side view of the apparatus shown in FIG. 1;

FIG. 5 is a diagrammatic cross-sectional view showing a guide member and a first hub attaching section of the center hub attaching apparatus shown in FIG. 1;

FIG. 6 is a schematic enlarged cross-sectional view showing the first hub attaching section shown in FIG. 5;

FIG. 7A is a plan view and FIG. 7B is a bottom view, showing a disk cartridge; and

FIG. 8 is an enlarged cross-sectional view taken along line 8-8 in FIG. 7B.

### DESCRIPTION OF THE PREFERRED EMBODIMENTS

Embodiments of the present invention will hereinafter be described in detail with reference to the drawings.

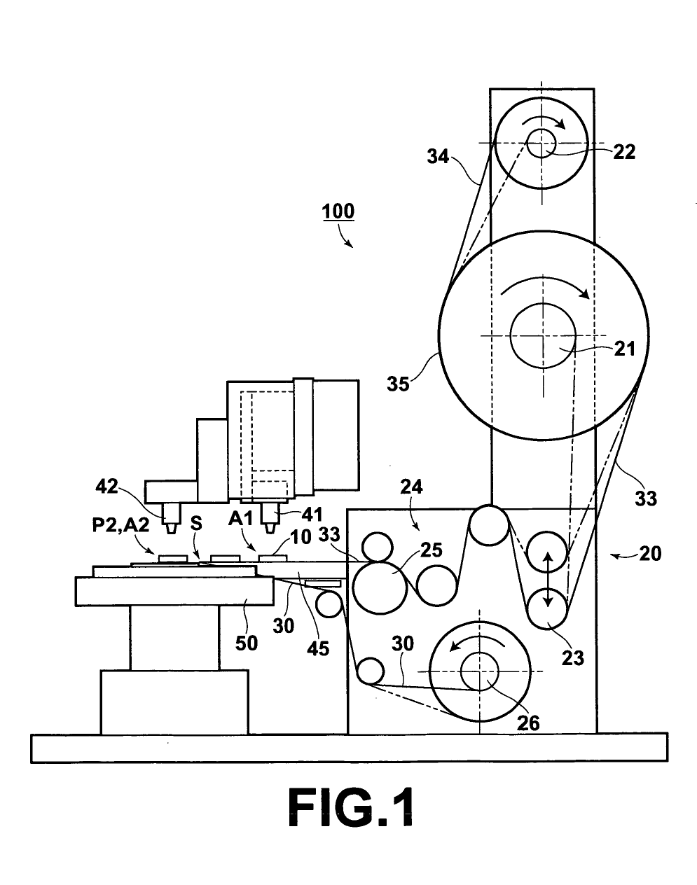

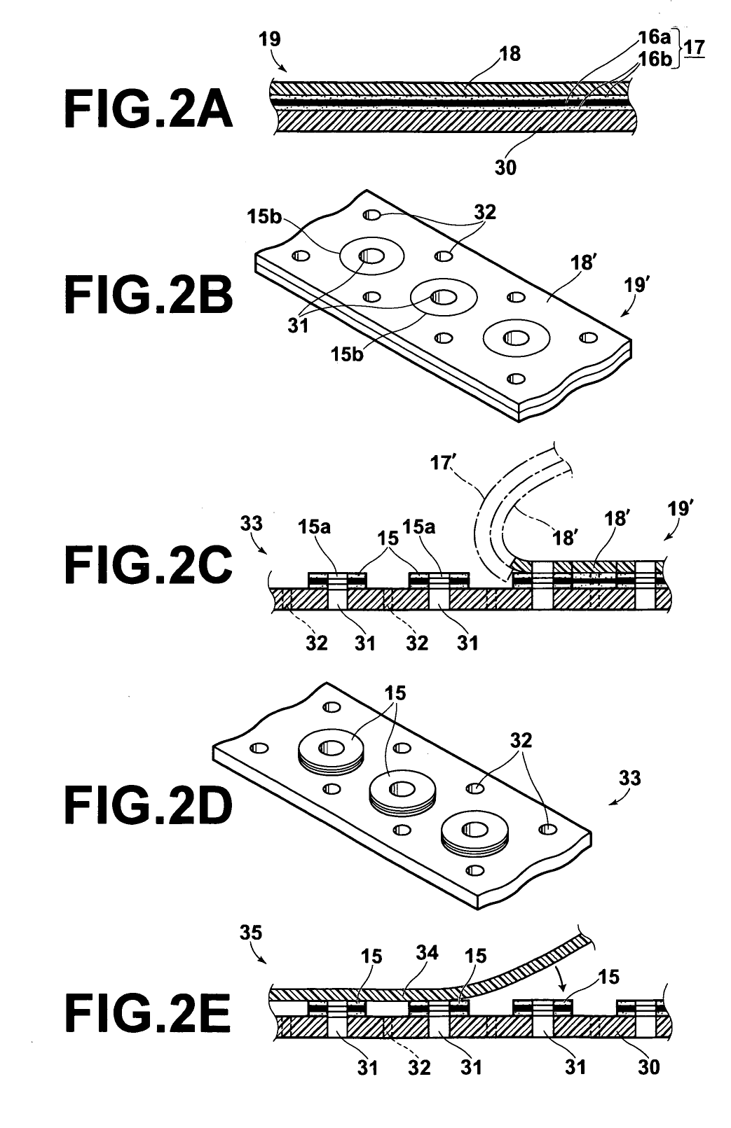

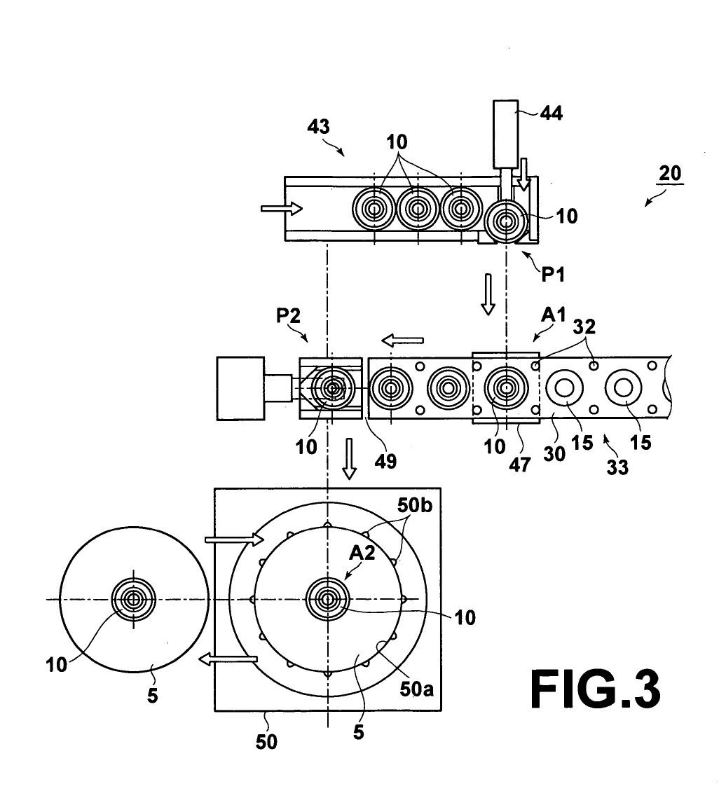

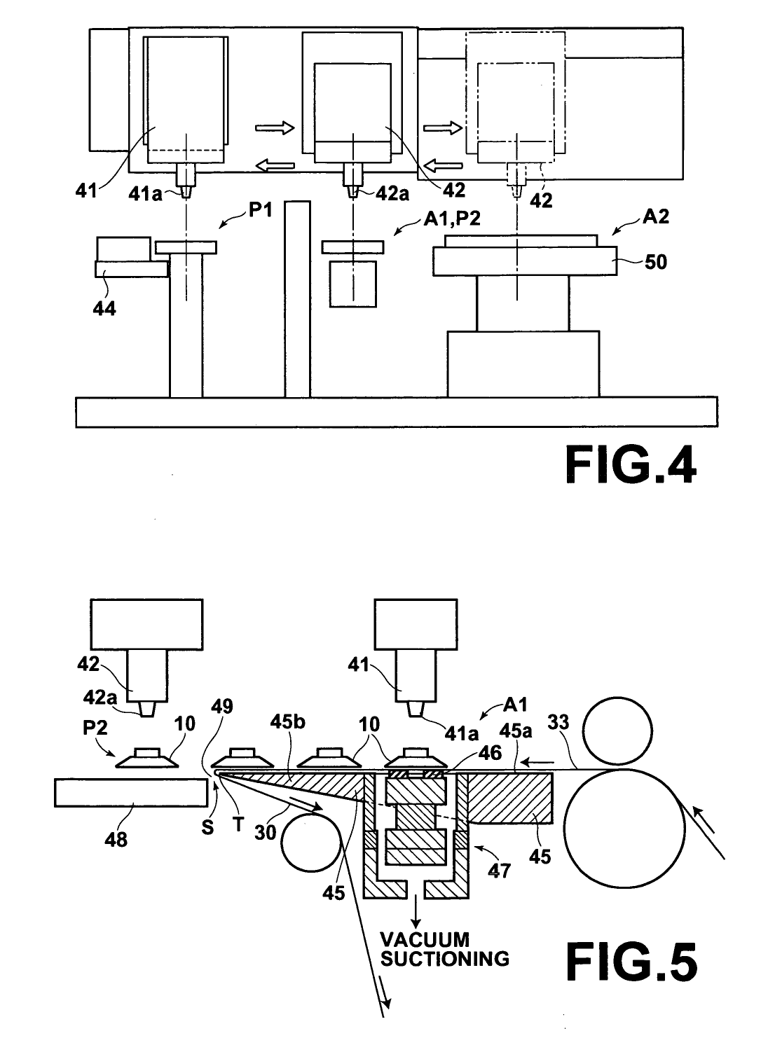

FIG. 1 is a schematic front view of a center hub attaching apparatus of the invention, FIGS. 2A to 2E are illustrative diagrams showing step by step a procedure for producing a carrying base film having thereon tacky rings used by the center hub attaching apparatus shown in FIG. 1, FIG. 3 is a schematic plan view showing an essential part of the center hub attaching apparatus in FIG. 1; and FIG. 4 is the side view thereof.

First, how to produce tacky rings, and details of a strip-like base film for carrying the tacky rings will be described with reference to FIGS. 2A to 2E.

First, a double sided adhesive tape 19 as shown in the enlarged cross-sectional view of FIG. 2A is provided. Similar to conventional double sided adhesive tapes, the aforementioned double sided adhesive tape 19 comprises a base film 30, a release liner 18, and a double sided adhesive film 17 disposed therebetween. The double sided adhesive film 17 is constituted by a substrate film 16a and adhesive layers 16a and 16b which have been applied to opposite surfaces of the substrate film 16.

As shown in the perspective view of FIG. 2B, circular holes 31 having substantially the same size as a center hole 15a of a tacky ring 15 and perforations 32 are then formed in the base film 30 as through holes extending through both the double sided adhesive tape 19 and the release liner 18 such that the circular holes 31 and the perforations 32 are respectively evenly spaced along the longitudinal direction of the base film 30. Further, a half-cut is provided in the base film 30 concentrically around each circular hole 31 such that the half-cut circumferentially extends along a circle having a diameter 15b, which is the same as the outer diameter of the tacky ring 15. Thus, a perforated double sided adhesive tape 19′ having thereon a perforated release liner 18′ is provided.

After that, a release-liner-laminated base film 35 is provided formed by: removing an unnecessary double sided adhesive film 17′ together with a perforated release liner 18′ from the surface of the base film 30 as shown in the enlarged cross-sectional view of FIG. 2C; providing a tacky-ring-carrying base film 33 having tacky rings 15 arranged in series on the surface of the base film 30 as shown in FIG. 2D; and applying to the tacky-ring-carrying base film 33 a release liner 34 intended for preventing the tacky rings 15 from being adhered to the tacky-ring-carrying film 33 disposed adjoining the tacky rings 15 when the tacky-ring-carrying film 33 is wound around a base film supply spool 21 (see FIG. 1) as shown in FIG. 2E.

The release-liner-laminated base film 35 is wound around the base film supply spool 21 incorporated in a base film supply/take-up mechanism 20 illustrated on the right-hand side of a center hub attaching apparatus 100 in FIG. 1. During feeding, the release liner 34 is in the form of the tacky-ring-attached base film 33 as shown in FIG. 2D and threaded through a roller group 24 including a dancer roller 23 and fed toward a first hub-attaching position A1 by means of a sprocket 25 while winding up the release liner by the take-up spool 23, so that the tacky rings are conveyed one by one to the first hub-attaching position A1.

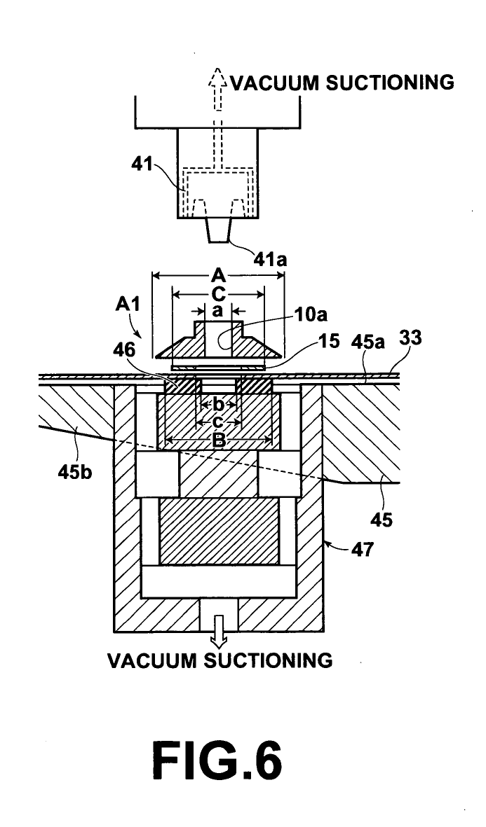

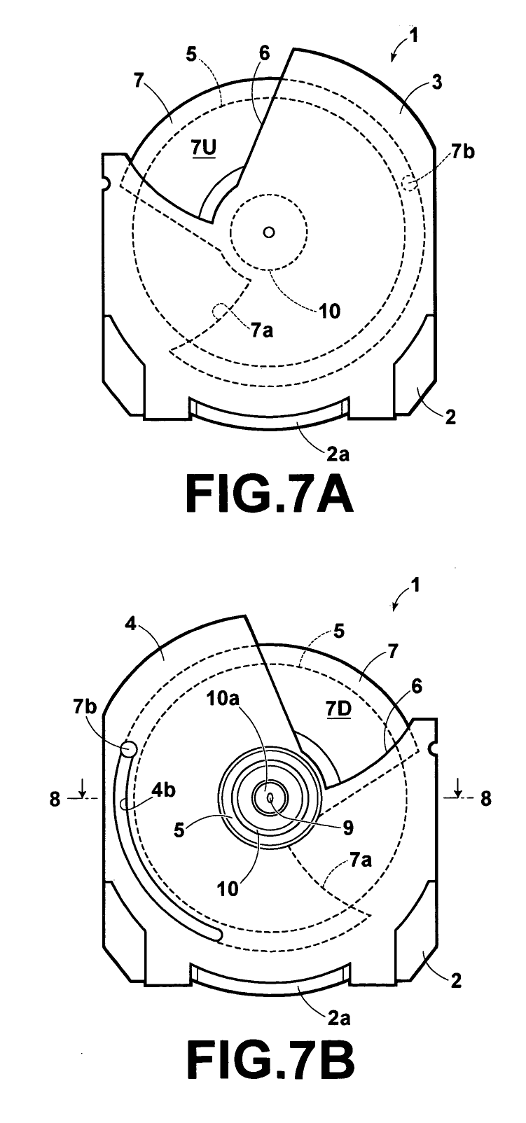

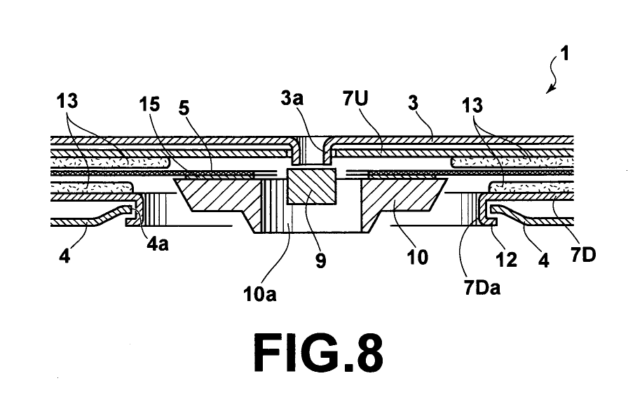

Each roller of the roller group 24 has a guide formed at each outer peripheral edge thereof such that the tacky rings 15 do not touch the roller surface. This center hub attaching apparatus 100 comprises, as shown in FIG. 4 and FIG. 6, a first vacuum-suction hub-attaching head 41 having a positioning pin 41a and a second vacuum-suction hub-attaching head 42 having a positioning pin 42a. Each positioning pin 41a, 42a is to be inserted into a center hole 10a of a center hub 10.

The first hub-attaching head 41 is provided in a manner to be reciprocally movable between a first hub-standby position P1 in a hub supply section 43 shown in an upper part of FIG. 3 and the aforementioned first hub-attaching position A1. More specifically, the first hub-attaching head 41 serves to pick up one of the center hubs 10 at the first hub-standby position P1; feed the center hub 10 to the first hub-attaching position A1; and attach the center hub 10 to a tacky-ring-attached base film 33 via a tacky ring 15 on the tacky-ring-attached base film 33. As a result, the tacky ring 15 on the base film 30 is attached to both the upper surface of the base film 30 and the lower surface of the center hub 10.

The aforementioned hub supply section 43 comprises a positioning member 44 for positioning one center hub 10 at a time to the first hub-standby position P1.

The second hub-attaching head 42 is provided in a manner to be reciprocally movable between a second hub-standby position P2 in a hub supply section 43 described later and the second hub-attaching position A2. After the base film 30 is peeled off at a base film peel-off position S from the tacky ring which has been attached to both the upper surface of the base film 30 and the lower surface of the center hub 10, the second hub-attaching head 42 serves to pick up the center hub 10 which is attached with a tacky ring 15 and is to be positioned to a second hub-attaching position A2; feed the center hub to the second hub-attaching position A2; and attach the center hub 10 to the central portion of a magnetic disk 5 via the tacky ring 15.

Referring to FIG. 5, a guide member 45 having an upper surface 45a for guiding the tacky-ring-attached base film 33 to the first hub-attaching position A1 and then to the base film peel-off position S is disposed at the first hub-attaching position A1. The guide member 45 also has a wedge portion 45b disposed downstream along the traveling direction of the tacky-ring-attached base film 33. The apex T of the wedge portion 45b is located at the base film peel-off position S where the base film 30 is peeled off as described later. The apex T of the wedge portion 45b is rounded slightly such that the base film 30 is not cut.

Further, at the first hub-attaching position A1, a support table 47 having thereon an elastic ring pad 46 for receiving the lower surface of the base film 33 is secured, as shown in FIG. 6, to the guide member 45.

The aforementioned elastic ring pad 46 is made of a material, such as urethane rubber or silicone rubber, having a rubber hardness of about A50° to A80°, and formed to have an outer diameter B (about 13 mm) which is smaller than the outer diameter A (about 15 mm) of the center hub 10 and larger than the outer diameter C (about 11 mm) of the tacky ring 15. Further, the elastic ring pad 46 has an inner diameter b which is larger than the inner diameter a of the center hole 10a of the center hub 10 and smaller than the inner diameter c of the center hole 15a of the tacky ring 15. Further, there is provided a vacuum suction device for attracting a region around the elastic pad 46 under suction with a negative pressure of −50 KPa or less when the center hub 10 is attached. Further, the speed that the center hub 10 and the tacky ring 15 approach one another is preferably set to 100 mm/s or less.

For the sake of clarity, the tacky-ring-attached base film 33 and the center hub 10 are shown as if they are suspended above the upper surface 45a of the guide member 45 in FIGS. 5 and 6 and the tacky ring 15 is shown as if the tacky ring 15 is separated from the tacky-ring-attached base film 33 and the center hub 10, whereas in reality, the tacky-ring-attached base film 33 and the center hub 10 are in contact with the upper surface 45a and the tacky ring 15 is in contact with the tacky-ring-attached base film 33 and the center hub 10.

As described above, after the center hub 10 is attached to the tacky-ring-attached base film 33 via the tacky ring 15 at the first hub-attaching position A1, that is, after the tacky ring 15 is attached to both the upper surface of the base film 30 and the lower surface of the center hub 10, and moved to the base film peel-off position S which is spaced downstream from the first hub-attaching position A1 along the tacky-ring-attached base film 33 traveling direction as shown in FIG. 5, the base film 30 is fed downward firstly through a gap 49 between the apex T of the wedge portion 45b and a center hub support table 48 adjacent thereto, and then, is folded back about the apex T of the wedge portion 45b and guided in a direction opposite to the tacky-ring-attached base film 33 traveling direction. As a result, the base film 30 is caused to be peeled off from the tacky ring 15 which has been attached to both the upper surface of the base film 30 and the lower surface of the center hub 10, and the center hub 10 having the tacky ring 15 on the lower surface thereof is then transferred onto the center hub support table 48 and positioned to the second hub-standby position P2.

In this case, since the base film peel-off position S is set, as described above, at a position spaced downstream from the first hub-attaching position A1 along the tacky-ring-attached base film 33 traveling direction, a certain short time (at least 3 seconds) elapses from the attachment of the tacky ring 15 onto the lower surface of the center hub 10 to the peel-off of the base film 30.

The base film 30 which has been peeled from the tacky ring 15 in the manner as described above is wound on the base film take-up spool 26 as shown in FIG. 1.

On the other hand, the second hub-attaching head 42 attracts the tacky-ring-attached center hub 10 positioned at the second hub-standby position P2, transports the attracted tacky-ring-attached center hub 10 to the second hub-attaching position A2, and attaches the center hub 10 to the central portion of the magnetic disk 5 via the tacky ring 15 which has been attached on the lower surface of the center hub 10.

A disk support table 50 including a recess 50a for receiving the magnetic disk 5 is provided at the second hub-attaching position A2, where a magnetic disk 5 is attached thereon with the center hub 10 and then the magnetic disk with the center hub 10 is removed outside by a disk take-out head having a similar configuration to that of the first and second hub-attaching heads 41 and 42.

In order to prevent the magnetic disk 5 from being attached to the bottom surface of the recess 50a by negative pressure when the magnetic disk 5 is being removed from the recess 50a, a plurality of vent passageways 50 which communicate with the recess 50a are provided around the recess 50a.

A specific embodiment of a center hub attaching apparatus in accordance with the present invention has been described for the purpose illustrating the manner in which the invention is made and used. According to the embodiment, the base film 30 is guided to be folded back about the apex T of the wedge portion 45b of the guide member 45 so that the base film 30 is peeled off from the tacky ring 14 which has been attached to both the upper surface of the base film 30 and the lower surface of the center hub 10. Therefore, the base film 30 is gradually peeled off from the front edge of the tacky ring 15, which ensures stable peeling. As a result, the problems of wrinkle occurrence on the tacky ring 15 and air entrapment between the center hub 10 and the magnetic disk 5 when the center hub 10 is attached to the magnetic disk 5 can be solved.

Further, according to the embodiment, the base film 30 is peeled off after a lapse of a predetermined time period from attachment of the center hub 10 on the base film 30 at the first hub-attaching position A1, and therefore the tacky ring 15 is more securely attached to the lower surface of the center hub 10. Accordingly, an effect of stabilizing the attached state of the center hub 10 with respect to the magnetic disk 5 is produced.

Still further, the apex T of the wedge portion 45b of the guide member 45 provided at the base film peel-off position S is located at a position spaced downstream from the first hub-attaching position A1 along the tacky-ring-attached base film 33 traveling direction, and therefore a certain time period elapses during movement of the tacky-ring-attached base film 33 from the first hub-attaching position A1 to the apex T of the wedge portion 45b. This makes it possible to produce the aforementioned effect.

Yet further, the elastic ring pad 46 which is provided at the first hub-attaching position A1 and serves to support the lower surface of the base film 33 has the aforementioned rubber hardness and the aforementioned dimensional relationship with respect to the center hub 10 and the tacky ring 15, which makes it possible to provide a stable attachment of the tacky ring 15 to the lower surface of the center hub 10.

While the present invention was described using a “clik! (registered trademark)” for exemplary purposes, it must be appreciated that the invention is not limited thereto but applicable to any other flexible magnetic disk.

What is claimed is:

1. An method of attaching a disk-shaped center hub of a disk cartridge to a rotary disk as an information recording medium, wherein the disk cartridge comprises the rotary disk; and a flat housing in which the rotary disk is rotatably held, and wherein the disk-shaped center hub is centrally attached to the rotary disk via a tacky ring formed of ring-shaped double sided adhesive tape material;
the method comprising the steps of:
(1) providing and arranging a plurality of the tacky rings on a strip-like carrying base film;
(2) feeding the base film such that at least one of the tacky rings is positioned at a first hub-attaching position;
(3) at the first hub-attaching position, temporarily attaching each center hub onto the base film via each tacky ring;
(4) guiding the base film in a direction in which the base film is folded back such that the base film is caused to be peeled off from the tacky ring which has been attached to both an upper surface of the base film and a lower surface of the center hub; and
(5) thereafter, at a second hub-attaching position, attaching the center hub onto the disk via the tacky ring which has been attached to the lower surface of the center hub.

2. The method as set forth in claim 1, wherein the base film is guided in a direction in which the base film is folded back about an apex T of a wedge portion of a guide member provided with the wedge portion, such that the base film is caused to be peeled off from the tacky ring.

3. The method as set forth in claim 1, wherein the base film is peeled off from the tacky ring after a lapse of a predetermined time period from attachment of the center hub onto the base film at the first hub-attaching position.

4. The method as set forth in claim 3, wherein the predetermined time period is at least 3 seconds.

5. The method as set forth in claim 2, wherein the base film is peeled off from the tacky ring after a lapse of a predetermined time period from attachment of the center hub onto the base film at the first hub-attaching position.

6. The method as set forth in claim 5, wherein the predetermined time period is at least 3 seconds.

7. An apparatus for attaching a disk-shaped center hub of a disk cartridge to a rotary disk as an information recording medium, wherein the disk cartridge comprises the rotary disk; and a flat housing in which the rotary disk is rotatably held, and wherein the disk-shaped center hub is centrally attached to the rotary disk via a tacky ring formed of ring-shaped double sided adhesive tape material;
the apparatus comprising:
base film driving means for driving and feeding a carrying base film with a plurality of the tacky rings being arranged on an upper surface of the base film, such that at least one of the tacky rings is positioned at a first hub-attaching position;
first hub-attaching means for attaching at the first hub-attaching position the center hub to the base film via the tacky ring;
guide means for guiding the base film in a direction in which the base film is folded back about an apex T of a wedge portion provided in the guide means, such that the base film is caused to be peeled off from the tacky ring which has been attached to both an upper surface of the base film and a lower surface of the center hub; and
second hub-attaching means for attaching at a second hub-attaching position the center hub to the disk via the tacky ring which has been attached to the lower surface of the center hub.

8. The apparatus as set forth in claim 7, wherein an apex of the wedge portion is located at a position spaced downstream from the first hub-attaching position along the base film traveling direction.
